(19) United States
(12) Patent Application Publication
(10) Pub. No.: US 2025/0184654 A1
(43) Pub. Date: Jun. 5, 2025

(54) MICROPHONE TRACKING BASED AUDIO PROCESSING

(71) Applicant: Shure Acquisition Holdings, Inc., Niles, IL (US)

(72) Inventors: Alex Mitchell, Skokie, IL (US); Stefan Marti, Oakland, CA (US)

(73) Assignee: Shure Acquisition Holdings, Inc., Niles, IL (US)

(21) Appl. No.: 18/959,882

(22) Filed: Nov. 26, 2024

Related U.S. Application Data
(60) Provisional application No. 63/605,280, filed on Dec. 1, 2023.

(51) Int. Cl. H04R 1/22; H04S 7/00

(52) U.S. Cl. CPC H04R 1/222; H04S 7/303; H04S 2400/11

(57) ABSTRACT

An audio system may include a microphone and an audio receiver that is communicatively coupled to the microphone. The receiver and/or the microphone may perform audio processing on one or more audio signals generated by the microphone. The audio processing may be based on a position of the microphone, a position of a user of the microphone (e.g., position of the user's mouth), and/or a relative position of the microphone and the user. The dynamic position-based audio processing provides for a customized and adaptive audio processing, such as a dynamically adjusted corrective equalization (EQ), compression, and/or advanced audio processing operation(s) that may use a machine learning algorithm. This advantageously improves the audio quality and performance in situations where the microphone is incorrectly positioned.

### CROSS REFERENCE TO RELATED APPLICATIONS

This patent application claims priority to, and the benefit of, U.S. Provisional Patent Application No. 63/605,280, filed Dec. 1, 2023, which is incorporated herein by reference in its entirety.

### TECHNICAL FIELD

Aspects of the disclosure relate to audio processing and object tracking systems, and more specifically to audio processing based on object tracking, such as microphone and/or user tracking.

### BACKGROUND

Musicians, speakers, and other users often incorrectly position the microphone during use. For example, the microphone may be held too far away, too close, and/or off-axis; and/or the user moves away from the microphone (e.g., user looks up and down at a podium or sheet music, causing large, sudden shifts in positioning). Such shifts in relative positions cause the microphone(s) to underperform, which may result in reduced audio quality (e.g., boomy, thin, or quiet sound). Current techniques use corrective equalization (EQ) and compression, but such techniques are fixed and do not provide adaptive solutions.

### SUMMARY

An example audio system may include a chain of discrete subcomponents, each configured to perform a specific audio processing functionality. For example, the subcomponents may include microphones, receivers, mixers, amplifiers, speakers, a personal stage monitor (PSM) system, musical instruments, general-purpose computing devices, etc. Aspects of the disclosure provide effective, scalable, and reliable technical solutions that address and overcome the problems associated with operation of audio systems, including incorrectly positioned microphones.

A microphone may include any type of microphone, such as but not limited to, a unidirectional microphone, a multidirectional microphone, an omnidirectional microphone, a dynamic microphone, a cardioid dynamic microphone, or a condenser microphone. The microphone may be configured to perform one or more audio mixing operations, digital signal processing (DSP), and/or other signal processing on the audio signals generated from detected audio (e.g., by one or more transducers) to generate processed audio data. The processing may be based on a position of the microphone, a position of the user's mouth, and/or a relative position of the microphone and the user's mouth. The audio data or processed audio data may be transmitted to an audio receiver for initial or further processing. The audio processing may be based on a position of the microphone, a position of the user (e.g., user's mouth), and/or a relative position of the microphone and the user (e.g., user's mouth). In one or more aspects, the microphone may transmit audio data to the receiver without performing audio processing on the audio signals that is based on the position of the microphone, the position of the user, and/or the relative position of the microphone and the user. The microphone may include the functionality for wireless communications, and/or be configured to interface with a communication module configured for wireless communications. In other aspects, the microphone may have a wired connection with the audio receiver.

In one or more aspects, the dynamic audio processing, based on a position of the microphone, a position of the user (e.g., user's mouth), and/or a relative position of the microphone and the user, provides for a customized and adaptive audio processing, such as a dynamically adjusted corrective equalization (EQ), compression, and/or advanced audio processing operation(s). This advantageously improves the audio quality and performance in situations where the microphone is incorrectly positioned.

### BRIEF DESCRIPTION OF THE DRAWINGS

The present disclosure is illustrated by way of example and not limited in the accompanying figures in which like reference numerals indicate similar elements and in which:

FIG. 1 shows an audio system including a microphone according to one or more exemplary embodiments.

FIG. 2 shows a receiver according to one or more exemplary embodiments.

FIG. 3 shows an audio system including a microphone and a tracking substance according to one or more exemplary embodiments.

FIG. 4A shows a microphone interfaced with a wireless communication module according to one or more exemplary embodiments.

FIG. 4B shows the microphone and wireless communication module of FIG. 4A, with the wireless communication module being disconnected from the microphone, according to one or more exemplary embodiments.

FIG. 5 shows an audio system including a microphone according to one or more exemplary embodiments.

FIG. 6 shows an audio system including a microphone and an audio accessory including a position sensor according to one or more exemplary embodiments.

FIG. 7 shows an adaptive positioned-based audio processing method according to one or more exemplary embodiments.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure. It is noted that various connections between elements are discussed in the following description. It is noted that these connections are general and, unless specified otherwise, may be direct or indirect, wired or wireless, and that the specification is not intended to be limiting in this respect.

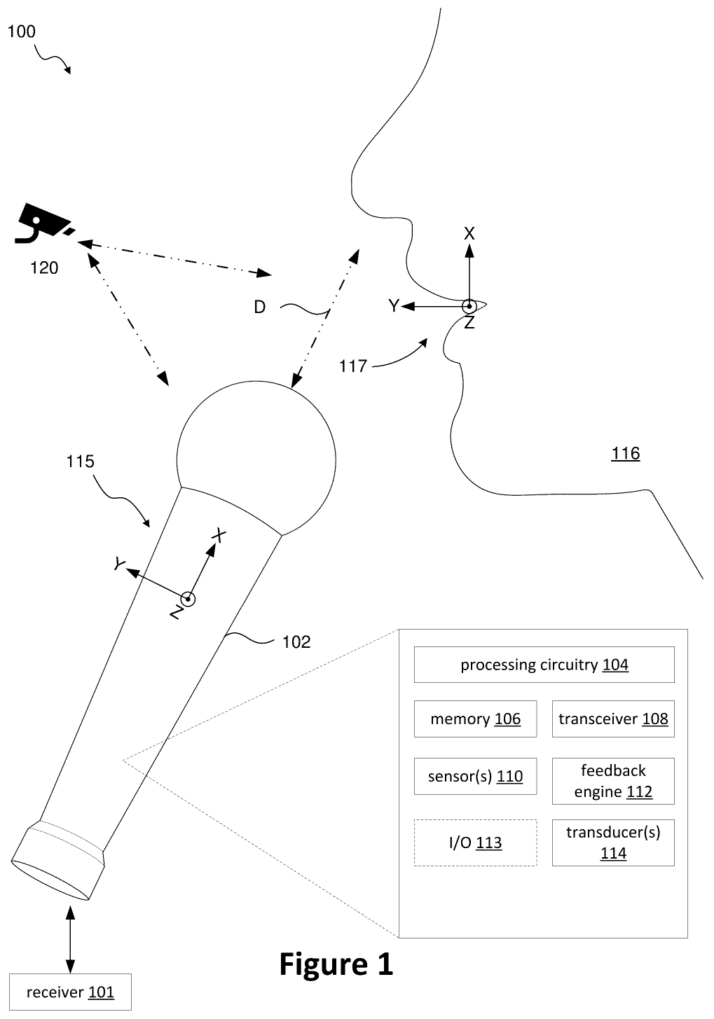

With reference to FIG. 1, an audio system 100 according to one or more exemplary embodiments may include a receiver 101 and a microphone 102. The audio system 100 may additionally include one or more sensors 120. The sensor(s) 120 may be configured to monitor the locations, positions, orientations, velocity, acceleration, and/or trajectories of the microphone 102, one or more users 116 of the microphone 102, and/or other objects within the environment. The sensor(s) 120 may include, for example, radio detection and ranging (RADAR), light detection and ranging (LIDAR), three-dimensional (3D) depth and time-of-flight sensors (ToF), optical sensors, infrared (IR) sensors, thermal imager(s), cameras, ultrasound sensors, inertial measurement sensors (e.g., inertial measurement unit(s) (IMU), which may include accelerometers, gyroscopes, magnetometers, compasses, etc.), indoor localization sensors (e.g., ultra-wide band (UWB) sensors), a face-detection system, or other sensors as would be understood by one or ordinary skill in the art. The sensor(s) 120 may communicate information (sensor data) with the receiver 101, microphone 102, and/or other devices of the audio system 100, using wireless and/or wired communication technologies. In aspects with multiple sensors 120, two or more of the sensors may be configured to communicate with each other.

The audio system 100 may be implemented with one or more other audio subcomponents to form an audio system that includes a chain of discrete subcomponents, each configured to perform a specific audio processing functionality. For example, the subcomponents may include microphone(s) 102, receiver(s) 101, mixer(s), amplifier(s), speaker(s), musical instrument(s), general-purpose computing devices, etc.

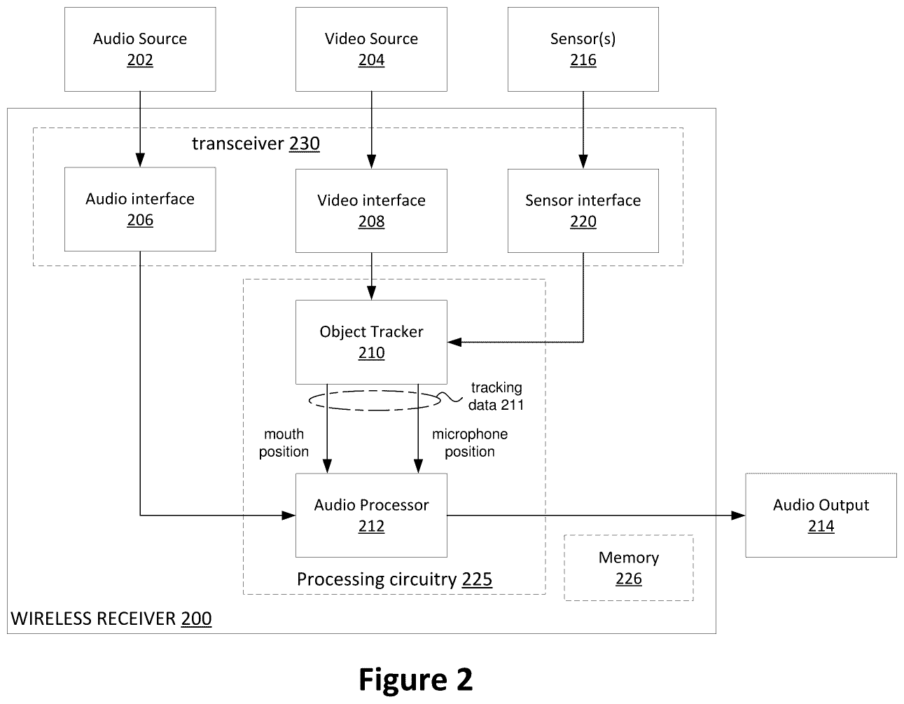

As an example, an audio system 100 may receive audio from one or more microphones 102 (and/or other audio sources), and process the audio via receiver 101, a mixer, and/or amplifier(s), prior to outputting the audio (audio output 214 in FIG. 2) via one or more speakers. Various examples herein describe the audio system 100 including microphone(s) 102 and the receiver 101, which may be connected to one or more other audio devices (e.g., speakers, musical instruments and/or instrument outputs, transmitters, transceivers, sensors, computing devices, etc.).

The receiver 101 may be located, for example, at a sound board or sound booth, and configured to receive audio data from the microphone 102. In one or more aspects, as described in more detail below, the microphone 102 may include one or more internal sensors 110. In these aspects, the receiver 101 may be configured to receive sensor data from the microphone 102, which may represent the locations, positions, orientations, velocity, acceleration, and/or trajectories of the microphone 102, a distance of the microphone 102 from one or more objects (e.g. user 116), and/or a relative position, location, orientation of the microphone 102 with respect to the user 116 and/or other object(s). “Positional information,” “position information,” and/or “tracking data” may be used to refer to location(s), position(s), orientation(s) (e.g., angle), velocit(ies), acceleration(s), and/or trajector(ies) of the microphone 102, user 116, and/or other object(s), and/or relative position(s), location(s), orientation(s), etc. of the microphone 102 with respect to the user 116 and/or other object(s).

The receiver 101, microphone 102, and/or sensor(s) 120 may be configured to transmit and/or receive signals using one or more communication protocols, such as, the Bluetooth protocol, an Institution of Electrical and Electronics Engineers (IEEE) 802.11 WIFI protocol, a 3rd Generation Partnership Project (3GPP) cellular protocol, a local area network (LAN) protocol, a hypertext transfer protocol (HTTP), FM radio, infrared, one or more optical protocols, fiber optics, industrial, scientific, and medical (ISM) bands defined by the International Telecommunication Union (ITU) Radio Regulations (e.g., a 2.4 GHz-2.5 GHz band, a 5.75 GHZ-5.875 GHz band, a 24 GHz-24.25 GHz band, and/or a 61 GHZ-61.5 GHz band, etc.), a very high frequency (VHF) band (e.g., 30 MHz-300 MHz band) and/or via (e.g., one or more channels within) an ultra-high frequency (UHF) band (e.g., 300 MHz-3 GHZ). The communication protocols that may be used are not limited to these example protocols.

With continued reference to FIG. 1, the microphone 102 may include processing circuitry (e.g., one or more of processor(s)) 104, memory 106, transceiver(s) 108, sensor(s) 110, feedback engine (e.g., haptic engine) 112, input/output (I/O) interface(s) 113, and/or transducer(s) 114. One or more data buses (not shown) may interconnect the processing circuitry 104, memory 106, transceiver(s) 108, sensor(s) 110, feedback engine 112, I/O interface(s) 113, and/or transducer(s) 114. The microphone 102 may be implemented using one or more integrated circuits (ICs), software, or a combination thereof, configured to operate as described herein. The memory 106 may be any memory, such as a random-access memory (RAM), a read-only memory (ROM), a flash memory, or any other electronically readable memory, or the like. The memory 106 may include one or more memory units.

The processing circuitry 104 may be configured to perform one or more functions of the microphone, including controlling function(s) performed by one or more components of the microphone. The processing circuitry 104 may be configured to execute machine readable instructions stored in memory 106 to perform one or more operations described herein.

For example, the processing circuitry 104 may control the communication of data via the transceiver 108, and/or control the communication of data via the I/O interface 113. Signals transmitted from and/or received by the microphone 102 (via transceiver 108 and/or I/O interface 113) may be encoded in one or more data units. For example, the processing circuitry 104 may be configured to generate data units (e.g. encode signal(s) into data unit(s), and process received data units (e.g., decode data unit(s) into signal(s)), that conform to any suitable wired and/or wireless communication protocol. The transceiver 108 may be configured to send/receive signals to/from microphone 102 using one or more communication protocols. The communication protocols may be any wired communication protocol(s), wireless communication protocol(s), and/or one or more protocols corresponding to one or more layers in the Open Systems Interconnection (OSI) model (e.g., a LAN protocol, an IEEE 802.11 WIFI protocol, a 3GPP cellular protocol, an HTTP, a Bluetooth protocol, etc.).

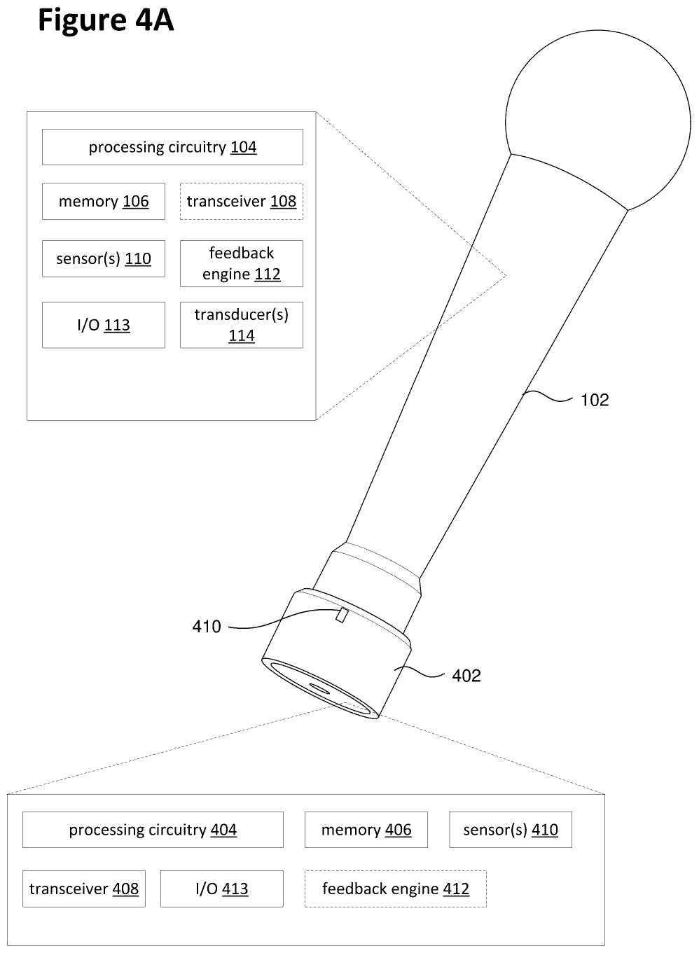

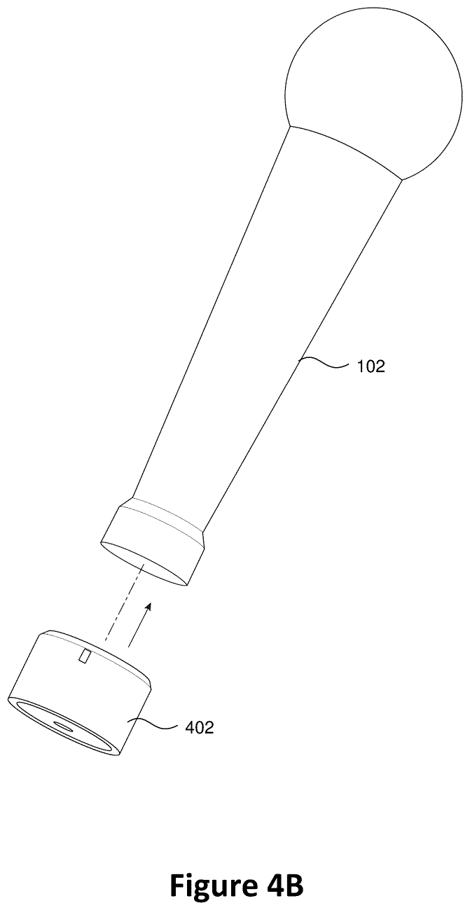

The I/O interface 113 may include one or more input connections configured to receive input data and/or signals using one or more wired (e.g., audio cables) and/or wireless communication protocols, and/or may include one or more input devices (e.g., keyboard, control panel, graphical user interface (GUI), human-machine interface, or the like). Additionally, or alternatively, the I/O interface 113 may include one or more output connections configured to transmit output data and/or signals using one or more wired and/or wireless communication protocols, and/or may include one or more output devices (e.g., speaker, lights, display, GUI, etc.). The I/O interface 113 may include a dedicated audio interface (e.g., 3.5 mm connector), a general-purpose interface (e.g., a universal serial bus (USB) connector), an Ethernet connector, an XLR connector, or any other type of interface. The I/O interface 113 may be configured to interface with one or more microphone accessories, such as a removable (e.g., plug-in) wireless transceiver module (e.g. transceiver 402 with reference to FIGS. 4A-4B). The I/O interface 113 may be configured to transmit one or more outputs that allow the microphone 102 to output audio signals and/or data. The audio signals and/or data may be output on one or more channels. In an exemplary embodiment, the I/O interface 113 may be configured to output one or more notifications, such as one or more audio and/or visual notifications, which may be used to indicate a correct or incorrect position of the microphone to the user 116. For example, the I/O interface 113 may include one or more speakers and/or lights to provide a notification or indicator to the user 116.

The processing circuitry 104 may be configured to generate one or more notifications, which may be communicated using the I/O interface 113, feedback engine 112, and/or transceiver 108. The notification(s) may be generated to communicate to the user 116 that the microphone 102 is improperly positioned and/or properly propositioned, to a communicate a corrective measure (e.g., a movement that should be taken to correctly position the microphone) to the user 116, and/or one or more other notifications. In an exemplary embodiment, the processing circuitry 104 may be configured to control the feedback engine 112 to generate user-perceivable feedback to communicate a particular notification to the user 116 holding the microphone 102. The feedback may include haptic feedback (e.g., vibration), proprioceptive feedback (e.g., changing of the shape of the microphone 102 or a portion thereof), tactile feedback (e.g., changing surface texture), and/or other feedback modalities as would be understood by one of ordinary skill in the art. For example, the haptic feedback may be used to convey information through a kinaesthetic sensing modality by generating forces, vibrations, and/or motion (e.g., using one or more eccentric rotating mass (ERM) actuators, one or more piezoelectric actuators, etc.) that is perceivable by the user 116. The proprioceptive feedback may be used to convey information through the proprioceptive sensing modality by, for example, using one or more robotic actuators configured to temporally deform and/or change the shape of the microphone 102 and/or a portion thereof (e.g., non-rigid portion). The tactile feedback may be used to convey information through the tactile sensing modality by changing the surface texture of a surface of the microphone 102 (e.g., changing a smooth surface to a rough surface) using, for example, one or more micro fluidic actuators. Additionally, or alternatively, the feedback may include a fluctuation in temperature (e.g., causing the microphone 102 or a portion thereof to become cooler or hotter) to communicate a particular notification to the user 116 holding the microphone 102 (e.g., generate a colder temperature to indicate an improper position of the microphone 102).

The transducer(s) 114 may be configured to convert sound waves (e.g., acoustic energy) into electrical signals. For example, the transducer(s) 114 may capture audio from the user 116 and convert the detected audio and/or sound into electrical signal(s) corresponding to the detected audio and/or sound, which may be referred to as audio signal(s).

The sensor(s) 110 may be configured to generate sensor data indicative of the locations, positions, orientations, velocity, acceleration, and/or trajectories of the microphone 102 and/or a distance D of the microphone 102 to an object (e.g., the face, mouth, and/or lips of the user 116). In an exemplary embodiment, the sensor(s) 110 may be configured to generate multi-dimensional coordinate data 115 (e.g., X-Y-Z coordinates) of the microphone 102.

The sensor(s) 110 may include radar, LIDAR, three-dimensional (3D) depth and time-of-flight sensors (ToF), optical sensor(s), thermal imager(s), camera(s), ultrasound sensors, positioning systems for localization, position sensor(s), angle sensor(s), inertial measurement sensors (e.g., inertial measurement unit(s) (IMU), which may include accelerometers, gyroscopes, magnetometers, compasses, etc.), indoor localization sensors (e.g., ultra-wide band (UWB) sensors), a face-detection system, or other sensors as would be understood by one or ordinary skill in the art. Thus, the sensor data may indicate the location, position, and/or orientation of the microphone 102, and/or the presence of and/or range to the user 116. The processing circuitry 104 of the microphone 102 may process sensor data from the sensor(s) 110 to identify characteristics (e.g., location, position, orientation, etc.) of the microphone 102 and/or component(s) thereof, characteristics of objects (e.g., user 116) in the proximity of the microphone 102, and/or other information as would be understood by one of ordinary skill in the art.

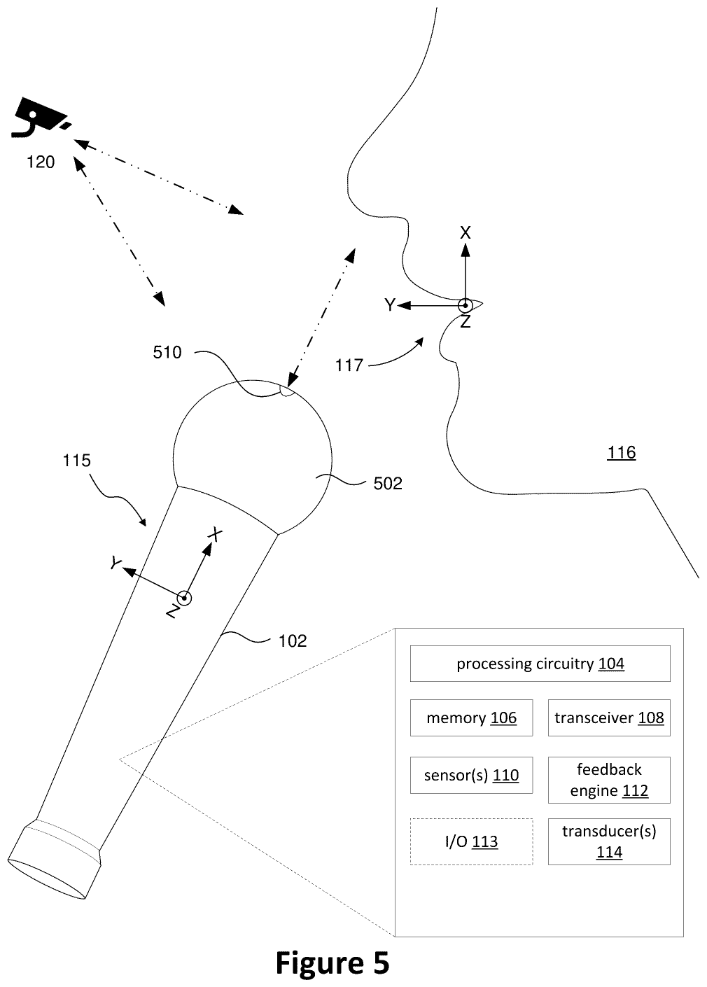

In an exemplary embodiment, with reference to FIG. 5, the sensor(s) 110 may include one or more sensors 510 comprised within the windscreen and/or cover 502 of the microphone 102 that may, for example, cover and/or house the audio transducer(s) 114 of the microphone 102. In an exemplary embodiment, the sensor(s) 510 may be an on-axis sensor (e.g. axially arranged along the X-axis) whose detection area is partially or completely arranged on and/or extends along an axis (e.g., X-axis, longitudinal axis) of the microphone 102. The sensor(s) 510 may be, for example, a thermal imaging sensor (thermal imager), such as a thermographic sensor or camera. The thermal imaging sensor may be configured to creates an image using IR radiation, similar to a normal camera that forms an image using visible light. The thermal imaging sensor may be configured to detect facial features of the user 116 using thermography technologies.

The microphone 102 may use sensor data generated by one or more of the onboard sensor(s) 110 and/or environmental sensor(s) 120 to identify, for example, locations, positions, orientations, velocity, acceleration, direction and/or trajectories of the microphone 102 to determine its relationship (e.g., relative position) to the user 116 (e.g., the user's lips) to facilitate adaptive audio processing of audio signals (e.g., by processing circuitry 104) generated from audio and/or sound detected/captured by the microphone 102. As described in more detail below, the sensor data may be used by the microphone 102 and/or the receiver 101 to adaptively control one or more audio processing operations performed on the audio signals. In an exemplary embodiment, the sensor(s) 120 may be configured to generate multi-dimensional coordinate data 117 (e.g., X-Y-Z coordinates) of the user 116 (e.g., of the lips of the user 116) and/or generate multi-dimensional coordinate data 115 (e.g., X-Y-Z coordinates) of the microphone 102. In an exemplary embodiment, the processing circuitry 104 may be configured to determine mapping data based on the sensor data (e.g., coordinate data 115 and/or 117). The mapping data may reflect the position, location, orientation, etc. of the microphone 102, the position, location, orientation, etc. of the user 116, and/or a relative position, location, orientation, etc. of the microphone 102 and the user 116. Additionally, or alternatively, the processing circuitry 104 may be configured to determine a vector between the microphone 102 and the user 116. The sensor data and/or vector(s) may include one or more degrees of freedom (DoF), which may include forward-back, right-left, up-down, roll, pitch, and/or yaw. For example, the sensor data and/or vector(s) may include six degrees of freedom (6DoF) including the forward-back movement, right-left movement, up-down movement, roll, pitch, and yaw of the microphone 102 and/or user 116.

In an exemplary embodiment, the processing circuitry 104 may be configured to perform one or more audio processing operations on one or more audio signals generated by the microphone 102 (e.g. by transducer 114). In this example, the processing circuitry 104 may include one or more audio processors configured to perform one or more audio processing operations. In an exemplary embodiment, the processing circuitry 104 may be configured to, based on sensor data generated by the sensor(s) 110 and/or sensor(s) 120, perform one or more audio processing operations on audio signal(s) generated by the microphone 102 (e.g. by transducer 114), adjust the audio processing operation(s), and/or otherwise control the audio processing operation(s), to facilitate adaptive audio processing of audio signal(s) generated from audio and/or sound detected/captured by the microphone 102. For example, if the user 116 moves the microphone 102 away from their mouth and/or positions the microphone 102 at a sub-optimal angle, the processing circuitry 104 may adjust one or more audio processing operations, perform one or more audio processing operations, and/or halt one or more current audio processing operations. In an exemplary embodiment, the position and/or orientation of the transducer(s) 114 may be adjustable (e.g., automatically adjustable) based on sensor data generated by the sensor(s) 110 and/or sensor(s) 120 to compensate for an incorrect and/or sub-optimal position, location, orientation, etc. of the microphone 102 (e.g., with respect to the user 116). For example, processing circuitry 104 may be configured to control one or more actuators, pan-tilt modules, motors, etc. configured to move or otherwise adjust the position and/or orientation of the transducer(s) 114 based on the sensor data. Additionally, or alternatively, the transducer(s) 114 may be configured to have a steerable microphone beam that is steerable by the processing circuitry 104 based on the sensor data.

The audio processing operations may include, for example, adjustment of audio levels, panning, equalization (EQ), dynamic EQ, compression, multiband compression, dynamic range adjustments, limiting, summing, filtering, noise reduction, reverb, gain, delay, gating, expansion, de-essing, ducking, saturation, harmonic distortion, one or more modulation effects, sidechaining, adjustments to one or more other audio parameters, adjustment(s) in the frequency and/or time domain, timbre adjustment(s), and/or one or more other audio processing operations.

Panning may include the process of placing audio elements in the stereo field, so that they appear to come from a particular location in the audio spectrum. For example, by adjusting the left-right balance of a signal, panning may create a sense of space and dimensionality in a mix. Equalization (EQ) may include the process of adjusting the frequency balance of audio tracks to improve balance and/or clarity. Equalization may include cutting or boosting specific frequency ranges to remove unwanted frequencies or enhance desired ones, and/or may be used to achieve a desired tone or timbre. Dynamic EQ may include adjusting the gain of certain frequency bands based on the input level of the audio signal, and may be useful in controlling harsh frequencies or taming certain resonances. Compression may include the process of reducing the dynamic range of audio tracks, making loud sounds quieter and quiet sounds louder. By reducing the difference between the loudest and softest parts of a track, compression may provide a more consistent and controlled audio. Multiband Compression is similar to compression, but instead of applying a single level reduction to the entire audio signal, it applies different levels of compression to different frequency bands. Multiband compression may be used to balance out a mix that has a lot of frequency imbalances. Summing may include adding together two or more audio signals to create a single output signal. The summing of audio signals may preserve the relative volume levels and stereo placement. Filtering may include the process of removing or attenuating certain frequencies in an audio signal, and may be used to remove unwanted noise and/or resonances, and/or to shape the tone of an audio signal. Noise reduction may include removing unwanted noise from an audio signal, such as removing hiss, hum, room echoes, room reverb, and/or other types of noise and/or unwanted acoustic events that may degrade the audio quality. Reverb may include simulating the acoustic environment of an audio signal, and may be used to add space, depth, and/or natural reverberation to an audio signal, and/or to create a sense of continuity between different parts of a mix. Gain may include adjusting the overall level of an audio signal, and may be used to balance levels of different audio tracks in a mix, and/or to increase or decrease the overall loudness of the audio track. Delay adjustments may include the introduction of a time delay between an audio signal and its output, and/or the introduction of echoes and/or repeats. Delay may be used to create stereo width and/or to create rhythmic effects. Gating may include the attenuating of an audio signal when it falls below a certain level, and may be used to remove unwanted noise and/or in controlling the decay of certain sounds. Expansion may be the opposite of compression, where instead of reducing the dynamic range of an audio signal, expansion increases it. Expansion may be used to increase the dynamic range and energy of a mix. De-essing may include the process of reducing the level of harsh sibilant sounds in an audio signal, such as “s” and “t” sounds. De-essing may make a mix sound less harsh and more pleasant to listen to. Ducking may include the reduction of the level of one audio signal when another audio signal is present. This can be useful in making a mix sound more cohesive and reducing clashes between different tracks. Saturation may include adding harmonic distortion to an audio signal, which may be used add warmth and character to a mix. Harmonic Distortion may include adding distortion to an audio signal to create new harmonic content. Modulation Effects may include effects (e.g., chorus, flanger, and phaser) that modulate certain aspects of an audio signal, such as pitch, frequency, and/or amplitude. Side chaining may include using the level of one or more audio signals to control the processing of one or more other audio signals. A side chain input may be used, for example, on a compressor or other processor, which allows the level of the separate audio signal(s) to control the amount of processing applied to the other audio signal(s). For example, in a music mix, a side chain input can be used to trigger a compressor on a bass track using the kick drum track as the side chain input. This may cause the bass to be compressed every time the kick drum hits, which can help to create a more cohesive and tight rhythm section. In another example, side chaining may be used in other applications, such as where a music track can be automatically ducked (e.g. reduced in volume) whenever the voiceover is present to ensure that the voiceover remains clear and audible over the music.

In one or more exemplary embodiments, the audio processing operations may additionally or alternatively include one or more advanced processing algorithms, such as audio processing that uses one or more machine learning (ML) algorithms and/or models to adjust audio and/or mixing parameters, and/or control one or more audio processing operations of the processing circuitry 104. The advanced audio processing techniques may include spatialization, denoising, auto mixing, and/or one or more other audio processing operations utilizing one or more ML algorithms. Spatialization may create a sense of space, such as width, depth, and height, within an audio mix by, for example, placing different sounds in different locations within the stereo or surround sound field, creating a more immersive and realistic listening experience. Spatialization techniques may include panning, reverberation, and delay effects, as well as more advanced techniques like binaural and ambisonic processing. Denoising may include removing unwanted noise and/or unwanted sound events from an audio signal (e.g., drum bleed). Noise can come from a variety of sources, including background hum, hiss, wind, or electronic interference. Depending on context, noise may also include uninvolved voices in the background, audience noises, traffic noises (e.g., vehicle noises, construction noises, etc.), animal noises, machinery noises (e.g., vacuum cleaner, robotic vacuum, garbage disposal, coffee machine, dishwasher, washer and dryers, other appliance noises, shower noises, etc.), weather and/or other environmental noises (e.g., rain, thunder, hail, wind, etc.). Denoising techniques may include spectral subtraction, noise gating, and/or adaptive filtering, as well as more advanced techniques like ML-based noise reduction algorithms. Denoising techniques may remove and/or attenuate unwanted noise while preserving the quality and clarity of the desired audio signal. Auto mixing may include one or more mixing operations that are at least partially automated (e.g. using ML). Auto mixing may include performing one or more audio processing operations to, for example, emphasize or deemphasize one or more channels. The emphasizing or deemphasizing channel(s) may be based on, for example, volume and gain modifications, spectral signal modifications (such as equalizing), dynamic signal compression and expansion, etc.

The ML algorithm(s) and/or model(s) may be executed by a computing system (e.g., processing circuitry) to progressively improve performance of the object tracking, audio processing, and/or one or more other tasks. In some aspects, parameters of a ML model and/or algorithm may be adjusted during a training phase based on training data. A trained ML model and/or algorithm may then be used during an inference phase to make predictions or decisions regarding object tracking and/or audio processing based on input data, such as sensor data/signals from one or more sensors and/or audio data/signals. The training data may be previous (e.g., historic) tracking data, audio data, and/or other data.

FIG. 2 shows a receiver 200 according to one or more exemplary embodiments. The receiver 200 may be a wireless receiver 200 configured to wirelessly communicate with one other devices, such as microphone 102 and/or other device(s) of an audio system. The receiver 200 may be an embodiment of the receiver 101 of FIG. 1.

The receiver 200 may be configured to receive audio signals transmitted from one or more audio sources 202, such as microphone 102, video signals transmitted from one or more video sources 204, such as sensor 120 (e.g. camera), and/or sensor signals from one or more sensors, which may include one or more sensors 110 of the microphone 102 and/or one or more environmental sensors 120. The audio signals, video signals, and/or sensor signals may be encoded in one or more data units (e.g., by processing circuitry 104 and/or transceiver 108). For example, the processing circuitry 104 may be configured to generate data units, which are transmitted to the receiver 200 by transceiver 108. The audio signals, video signals, and/or sensor signals may be received using respective interfaces, including audio interface 206, video interface 208, and sensor interface 220. The audio interface 206, video interface 208, and sensor interface 220 may collectively form transceiver 230 that may be configured to send/receive signals and/or data, using one or more communication protocols, to/from audio source(s) 202, video source(s) 204, sensor(s) 216, and/or other source(s).

The communication protocols may be any wired communication protocol(s), wireless communication protocol(s), and/or one or more protocols corresponding to one or more layers in the Open Systems Interconnection (OSI) model (e.g., a LAN protocol, an IEEE 802.11 WIFI protocol, a 3GPP cellular protocol, an HTTP, a Bluetooth protocol, etc.). The communication protocols may include the Bluetooth protocol, one or more IEEE 802.11 WIFI protocols, one or more 3rd Generation Partnership Project (3GPP) cellular protocols, local area network (LAN) protocol(s), a hypertext transfer protocol (HTTP), FM radio, infrared (IR), one or more optical protocols, fiber optics, ISM bands defined by the International Telecommunication Union (ITU) Radio Regulations (e.g., a 2.4 GHz-2.5 GHz band, a 5.75 GHz-5.875 GHz band, a 24 GHz-24.25 GHz band, and/or a 61 GHz-61.5 GHz band, etc.), a very high frequency (VHF) band (e.g., 30 MHz-300 MHz band) and/or via (e.g., one or more channels within) an ultra-high frequency (UHF) band (e.g., 300 MHz-3 GHZ). The communication protocols that may be used are not limited to these example protocols.

The transceiver 230 (e.g., audio interface 206, video interface 208, and/or sensor interface 220) may be configured to process received data units and/or data units to be transmitted, that conform to any suitable wired and/or wireless communication protocol. The processing circuitry 225 may decode the data unit(s) received by receiver 200.

In an exemplary embodiment, the receiver 200 may include an object tracker 210 and audio processor 212. In one or more embodiments, the object tracker 210 and/or audio processor 212 may be embodied as processing circuitry 225. The object tracker 210 and audio processor 212 may be embodied as distinct processing circuitry (e.g., separate processors).

The object tracker 210 and/or audio processor 212 (or collectively as processing circuitry 225) may be configured to perform one or more functions of the receiver 200, including controlling function(s) performed by one or more other components of the receiver 200. The processing circuitry 225 may be configured to execute machine readable instructions stored in memory 226 to perform one or more operations described herein. For example, the processing circuitry 225 may control the communication of data via the transceiver 230. Signals transmitted from and/or received by the receiver 200 (via transceiver 230) may be encoded in one or more data units. For example, the processing circuitry 225 may be configured to generate data units (e.g., encode signals as data units), and process received data units (e.g., decode data units into signals), that conform to any suitable wired and/or wireless communication protocol.

In an exemplary embodiment, the object tracker 210 may be configured to: determine a position, orientation, velocity, acceleration, trajectory, etc. of the audio source 202 (e.g., microphone 102), determine a position, orientation, velocity, acceleration, trajectory, etc. of the user 116 (e.g., of the user's face, lips, and/or mouth), and/or a relative position of the audio source(s) 202 to the user 116 (and/or other object) to facilitate adaptive audio processing of audio signals (e.g., by audio processor 212) received from the audio source(s) 202. These determinations may be based on video data from one or more video sources (e.g., sensor 120 embodied as a camera) and/or one or more other sensors 216 (e.g., sensor(s) 110, sensor(s) 410, and/or sensors 610). The video data and/or sensor data may be indicative of the location, position, orientation, etc. of the audio source 202 (e.g., microphone 102) and/or a distance D of the audio source 202 to an object (e.g., the face or mouth of the user 116). In an exemplary embodiment, the video data and/or sensor data may include multi-dimensional coordinate data 115 (e.g., X-Y-Z coordinates) of the microphone 102 and/or multi-dimensional coordinate data 117 (e.g., X-Y-Z coordinates) of the user 116 (e.g., of the lips of the user 116).

The object tracker 210 may process video data from the video source and/or sensor data from the sensor(s) 216 to identify characteristics (e.g., location, position, orientation, etc.) of the audio source(s) 202 and/or of one or more objects (e.g., user 116), characteristics of objects (e.g., user 116) in the proximity of the audio source(s) 202, and/or other information as would be understood by one of ordinary skill in the art.

The object tracker 210 may configured to generate tracking data 211 based on: the determined position, location, orientation, velocity, acceleration, trajectory, etc. of the audio source 202 (e.g., microphone 102); determined position, location, orientation, velocity, acceleration, trajectory, etc. of the object(s), such as user 116 (e.g., of the user's face, lips, and/or mouth); and/or the determined relative position of the audio source(s) 202 to the object(s). The tracking data 211 may be provided to the audio processor 212 to facilitate adaptive audio processing of audio signals from audio source(s) 202 (e.g., microphone 102). The tracking data 211 may include object tracking data (e.g., mouth position data corresponding to a position of the mouth of the user 116), audio source position data (e.g., microphone position data corresponding to a position of the microphone 102), and/or other sensor data from one or more sensors.

In an exemplary embodiment, the audio processor 212 is configured to perform one or more audio processing operations on the audio signals generated by the audio source(s) 202 and received via the audio interface 206. In an exemplary embodiment, the audio processor 212 may be configured to perform the audio processing operation(s) based on tracking data 211 from the object tracker 210. For example, the audio processor 212 may be configured to adaptively perform, halt, and/or adjust one or more audio processing operations based on the tracking data 211 from the object tracker 210 to customize and/or adapt audio processing of the audio signals to advantageously improve the audio quality and performance in situations where the microphone is incorrectly positioned. In an exemplary embodiment, the tracking data 211 may be associated with one or more audio processing operation(s) in one or more look-up tables (LUTs). In this example, the audio processer 212 may access the LUT(s) to determine, based on the corresponding tracking data 211, one or more audio processing operations and/or adjustment(s) of one or more audio characteristics to be performed on the audio signal(s).

The audio processing operations may include, for example, adjustment of audio levels, panning, equalization (EQ), dynamic EQ, compression, multiband compression, summing, filtering, noise reduction, reverb, gain, delay, gating, expansion, de-essing, ducking, saturation, harmonic distortion, one or more modulation effects, sidechaining, adjustments to one or more other audio parameters, and/or one or more other audio processing operations. In one or more exemplary embodiments, the audio processing operations may additionally or alternatively include one or more advanced processing algorithms, such as audio processing that uses machine learning (ML) to adjust audio and/or mixing parameters, and/or control one or more audio processing operations of the audio processor 212. The advanced audio processing techniques may include spatialization, denoising, auto mixing, and/or one or more other advanced audio processing operations.

In one or more exemplary embodiments, the audio source 202 (e.g., microphone 102) and/or the receiver 200 may be configured to perform adaptive positioned-based audio processing according to the disclosure. For example, adaptive positioned-based audio processing may be performed by the audio source 202, by the receiver 200, or by both the audio source 202 and the receiver 200. In aspects where the audio source 202 and the receiver 200 both perform adaptive positioned-based audio processing, the audio source 202 may perform an initial adaptive positioned-based audio processing on audio signal(s) to generate processed audio signal(s), and the receiver 200 may perform subsequent positioned-based audio processing on the processed audio signal(s) to generate processed audio output signal(s) 214.

For example, the microphone 102 may be configured to perform adaptive audio processing, based on the detected position, etc. of the microphone 102 and/or user 116, and provided the processed audio signal(s) to the receiver 101/200. The audio processor 212 of the receiver 200 may be configured to perform one or more additional audio processing operations on the processed audio signals received from the microphone 102 (audio source 202). The additional audio processing operation(s) performed by the audio processor 212 may be the same or different audio processing operation(s) as performed by the microphone 102. In one or more aspects in which the microphone 102 performs positioned-based audio processing according to the disclosure, additional audio processing by the receiver 200 may be omitted. In one or more exemplary embodiments, the microphone 102 may omit positioned-based audio processing according to the disclosure and pass audio signals to the receiver 101/200, where the receiver 101/200 then performs positioned-based audio processing according to the disclosure. This operation may be used, for example, to converse a power source (e.g., battery) of the microphone 102 and/or to offload processing to the receiver 200 that may have more processing power and/or capability as compared to the microphone 102.

In one or more exemplary embodiments, the receiver 200 (e.g., processing circuitry 225 or one of its components) and/or the audio source 202 (e.g., microphone 102) may control the distribution of the positioned-based audio processing between the receiver 200 and audio source 202. For example, receiver 200 may selectively perform, based on the tracking data 211 generated from data from sensor(s) 110 and/or sensor(s) 216, positioned-based audio processing and control the audio source 202 (e.g., microphone 102) to selectively perform additional audio processing or solely perform audio processing on the audio signal(s). For example, if the tracking data 211 calls for more extensive audio processing, the receiver 200 may control the microphone 102 to perform initial audio processing and provide the receiver 200 with processed audio signal(s) to distribute the processing and/or reduce the overall processing time. Additionally, or alternatively, the audio source 202 (e.g., microphone 102) may control the receiver 200 to selectively perform additional audio processing or solely perform audio processing on the audio signal(s) based on the tracking data. In one or more aspects, the audio source 202 (e.g., microphone 102) and the receiver 200 may cooperatively and/or jointly determine the distribution of the positioned-based audio processing and/or control of their own or another device's audio processing.

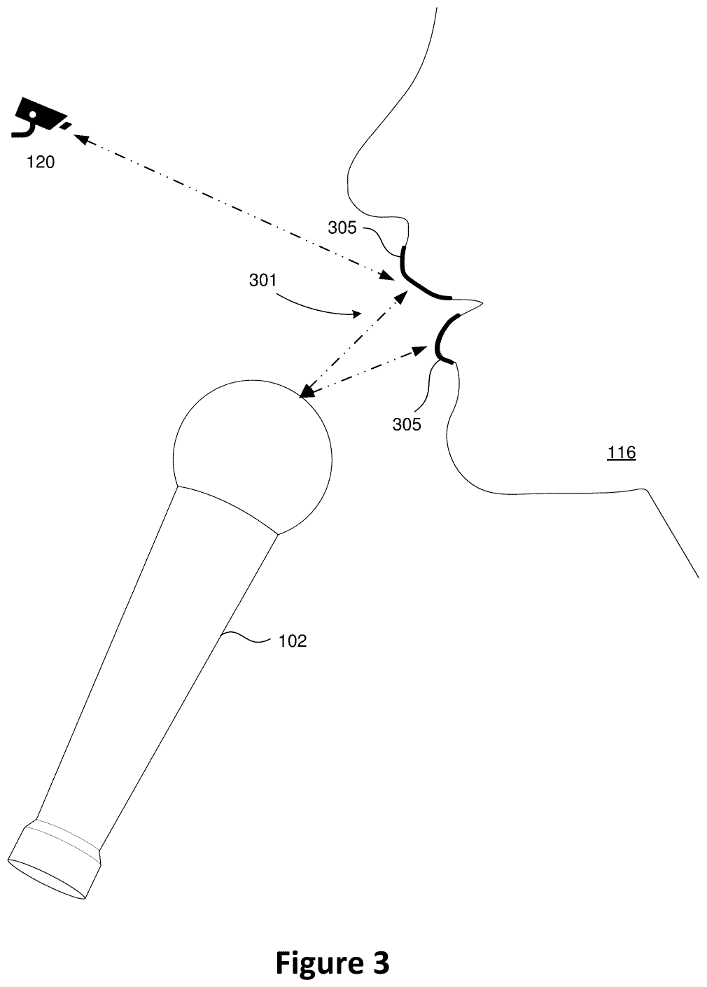

With reference to FIG. 3, in an exemplary embodiment, the user 116 may wear or otherwise apply a tracking substance or material 305 to their person to assist in the detection of movement and/or position of the user 116 by the sensor(s) 110 and/or sensor(s) 120. The tracking substance or material 305 may include, for example, a substance or material that is more easily detectable by sensor(s) 110 and/or sensor(s) 120 based on one or more physical properties of the tracking substance or material 305, the chemical composition of the tracking substance or material 305, and/or interaction(s) with the detection mechanism(s) of the sensor(s) 110 and/or sensor(s) 120. For example, the tracking substance or material 305 may exhibit characteristics that make it stand out or generate a stronger signal when interacting with the sensor(s) 110 and/or sensor(s) 120, leading to its heightened detectability and/or to an increased sensitivity and/or accuracy of the sensor(s) 110 and/or sensor(s) 120. For instance, tracking substance or material 305 may have a distinct odor, color, emit specific wavelengths of light, generate a unique electrical and/or magnetic signal, and/or produce a strong response in a particular sensing mechanism. The attributes of the tracking substance or material 305 may include higher reflectivity, conductivity, greater reactivity, and/or a specific molecular structure that makes it more detectable by the sensor(s). In an exemplary embodiment, the tracking substance or material 305 may be configured to increase a sensitivity and/or detectability of the tracking substance or material 305 by radar sensing technologies, LIDAR sensing technologies, optical sensing technologies, IR sensing technologies, radio-frequency (RF) sensing technologies, microwave sensing technologies, thermal sensing technologies, magnetic sensing technologies, and/or other sensing technologies as would be understood by one of ordinary skill in the art. For example, the tracking substance or material 305 may include an IR reflective substance that may be applied to the face of the user 116. In one example, the IR reflective substance may be a lipstick or lip balm that may be applied to the lip(s) 301 of user 116 to increase the detection of the user's lip(s) by an IR sensor of the sensor(s) 110 and/or sensor(s) 120. The application of the substance or material 305 is not limited to the lips of the user 116, and may be applied to other locations on the user 116, such as the teeth, tongue, nose, nostrils, chin, cars, facial hair (e.g., mustache, beard, etc.), eyebrows, eyelids, eyelashes, other facial areas, and/or other location(s) of interest. In another example, facial hair, eyebrows, and/or eyelashes may be dyed to increase the detectability by sensor(s) 110 and/or sensor(s) 120.

In an exemplary embodiment, the tracking substance or material 305 may include accessories (e.g., jewelry, glitter, stickers, patches, temporary and/or permanent tattoos, etc.) applied to the user 116, such as to the user's face. The accessories may be glued, fixed, or otherwise applied to the user's skin. In an example, the accessories may include jewelry (e.g., face jewels) that is glued on the lip(s) and/or face of the user 116. In another example, the accessories may include wearables that are glued, fixed, or otherwise applied to the user's skin, such as patches or other epidermal devices), and/or other on-skin devices that may be worn by the user 116 (e.g., smart watches, smart rings, fitness and/or vital monitoring devices, etc.). Such devices may be configured to receive user input (e.g., touch gestures) and/or provide output to the user 116 (e.g., audio, haptic, and/or visual output, haptic feedback, etc.). Additionally, or alternatively, the tracking substance or material 305 may be applied to clothing and/or accessories (e.g., user's glasses, jewelry, etc.) worn by the user 116, accessories and/or devices (e.g., instruments) held by the user 116, etc.

Turning to FIGS. 4A-4B, the microphone 102 may be configured to be connectable with one or more accessory modules 402. The accessory module 402 includes an I/O interface 413 that may be configured to connect to the I/O interface 113 of the microphone 102 to interface with the microphone 102. The accessory module 402 may be removably connected (e.g., plug-in) to the I/O interface 113 as illustrated in FIG. 4B. In an exemplary embodiment, the accessory module 402 is a wireless transceiver module (e.g., a plug-in wireless transceiver) that includes one or more transceiver(s) 408 configured to send and/or receive signals to/from microphone 102 using one or more communication protocols similar to transceiver 108. In this example, the wireless transceiver module 402 may be used for microphones lacking an internal transceiver 108, or as an additional transceiver to provide additional or redundant transceiving capabilities. In one or more aspects, the accessory module 402 may include a feedback (e.g., haptic) engine 412 configured similar to the feedback engine 112. In an exemplary embodiment, the I/O interface 413 may be configured to output one or more notifications, such as one or more audio and/or visual notifications, which may be used to indicate to the user 116 of a correct or incorrect position of the microphone.

In an exemplary embodiment, the accessory modules 402 may include one or more sensor(s) 410 that are configured to generate sensor data indicative of the location, position, orientation, etc. of the microphone 102 and/or a distance D of the microphone 102 to an object (e.g., the face or mouth of the user 116). In an exemplary embodiment, the sensor(s) 410 may be configured to generate multi-dimensional coordinate data 115 (e.g., X-Y-Z coordinates) of the microphone 102. Similar to sensor(s) 110, sensor(s) 216, and/or sensor(s) 610 (discussed below), the sensor(s) 410 may include radar, LIDAR, three-dimensional (3D) depth and time-of-flight sensors (ToF), optical sensor(s), infrared (IR) sensors, thermal imager(s), camera(s), ultrasound sensors, inertial measurement sensors (e.g., inertial measurement unit(s) (IMU), which may include accelerometers, gyroscopes, magnetometers, compasses, etc.), indoor localization sensors (e.g., ultra-wide band (UWB) sensors), positioning systems for localization, position sensor(s), angle sensor(s), face-detection system, or other sensors as would be understood by one or ordinary skill in the art. Thus, the sensor data may indicate the location, position, and/or orientation of the microphone 102, and/or the presence of and/or range to the user 116.

In an exemplary embodiment, the accessory module 402 may include processing circuitry 404 and memory 406, which may store instructions executable by the processing circuitry 404. For example, the processing circuitry 404 may be configured to process sensor data from the sensor(s) 410 to identify characteristics (e.g., location, position, orientation, etc.) of the microphone 102 and/or component(s) thereof, characteristics of objects (e.g., user 116) in the proximity of the microphone 102, and/or other information as would be understood by one of ordinary skill in the art. Additionally, or alternatively, the sensor data from sensor(s) 410 may be provided to the processing circuitry 104 of the microphone 102, which may process the sensor data from the sensor(s) 410 to identify characteristics (e.g., location, position, orientation, etc.) of the microphone 102 and/or component(s) thereof, characteristics of objects (e.g., user 116) in the proximity of the microphone 102, and/or other information as would be understood by one of ordinary skill in the art.

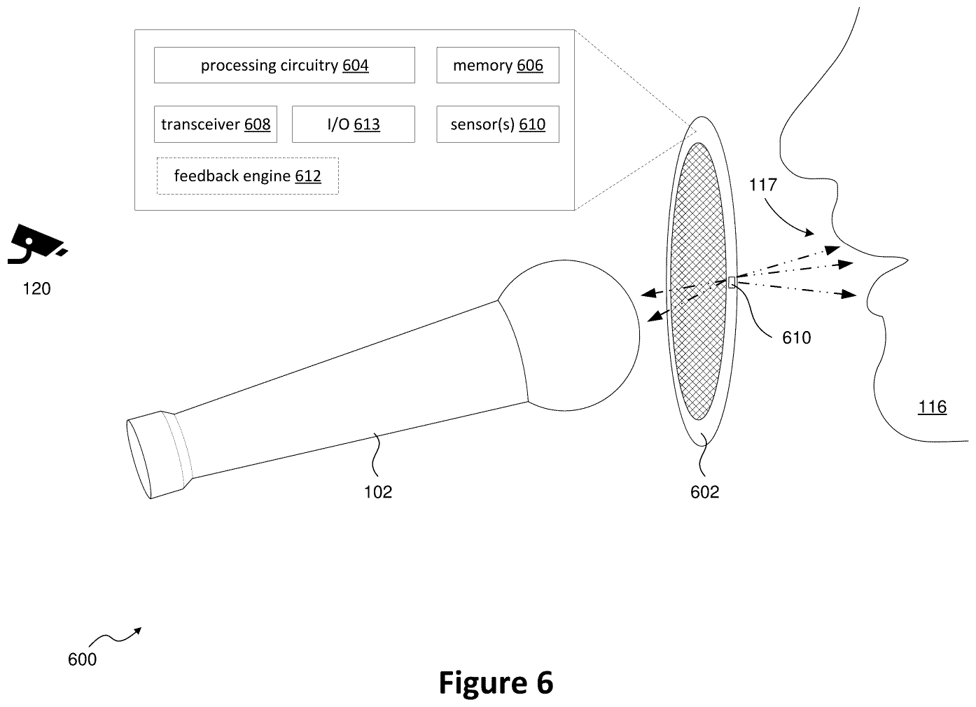

FIG. 6. illustrates an audio system 600 including a microphone 102 and an audio accessory 602 according to one or more exemplary embodiments. The audio accessory 602 may be a pop filter, spit guard, and/or other accessory or audio component used in audio recording environments.

The audio accessory 602 may include processing circuitry (e.g., one or more of processor(s)) 604, memory 606, transceiver(s) 608, sensor(s) 610, and/or I/O interface(s) 613. One or more data buses may interconnect two or more components of the audio accessory 602. The audio accessory 602 may be implemented using one or more integrated circuits (ICs), software, or a combination thereof, configured to operate as described herein. The processing circuitry 604 may be configured to perform one or more functions of the audio accessory 602, including controlling function(s) performed by one or more components of the audio accessory 602. The processing circuitry 604 may be configured to execute machine readable instructions stored in memory 606 to perform one or more operations described herein.

For example, the processing circuitry 604 may control the communication of data via the transceiver 608, and/or control the communication of data via the I/O interface 613. Signals transmitted from and/or received by the audio accessory 602 (via transceiver 608 and/or I/O interface 613) may be encoded in one or more data units. For example, the processing circuitry 604 may be configured to generate data units, and process received data units, that conform to any suitable wired and/or wireless communication protocol. The transceiver 608 may be configured to send/receive signals to/from audio accessory 602 using one or more communication protocols. The communication protocols may be any wired communication protocol(s), wireless communication protocol(s), and/or one or more protocols corresponding to one or more layers in the Open Systems Interconnection (OSI) model (e.g., a LAN protocol, an IEEE 802.11 WIFI protocol, a 3GPP cellular protocol, an HTTP, a Bluetooth protocol, etc.). The audio accessory 602 may be configured communicate with the microphone 102, the receiver 101/200, and/or one or more other devices using one or more wired and/or wireless communication protocols.

The sensor(s) 610 may be configured to generate sensor data indicative of the location, position, orientation, etc. of the microphone 102 and/or an object (e.g., the face, mouth, lips, nose, cars, eyes, and/or other facial and/or body parts of the user 116 and/or an accessory, object, substance, and/or device worn/held by and/or affixed to the user 116). Additionally, or alternatively, the sensor(s) 610 may be configured to determine a distance of the microphone 102 and/or the object (e.g., the face, mouth, and/or lips of the user 116) to the audio accessory 602. In an exemplary embodiment, the sensor(s) 610 may be configured to generate multi-dimensional coordinate data (e.g., X-Y-Z coordinates) of the microphone 102 and/or the user 116. Similar to sensor(s) 110, sensor(s) 216, and/or sensor(s) 410, the sensor(s) 610 may include radar, LIDAR, three-dimensional (3D) depth and time-of-flight sensors (ToF), optical sensor(s), thermal imager(s), camera(s), ultrasound sensors, inertial measurement sensors (e.g., inertial measurement unit(s) (IMU), which may include accelerometers, gyroscopes, magnetometers, compasses, etc.), indoor localization sensors (e.g., ultra-wide band (UWB) sensors), positioning systems for localization, position sensor(s), angle sensor(s), a face-detection system, or other sensors as would be understood by one or ordinary skill in the art. Thus, the sensor data may indicate the location, position, and/or orientation of the microphone 102, and/or the presence of and/or range to the user 116. As would be understood, the sensor(s) of sensor(s) 610 may include one or more sensors as described herein with respect to sensor(s) 110, sensor(s) 216, and/or sensor(s) 410, and vice versa.

The processing circuitry 604 may process sensor data from the sensor(s) 610 to identify characteristics (e.g., location, position, orientation, etc.) of the microphone 102 and/or component(s) thereof, characteristics of objects (e.g., user 116) in the proximity of the audio accessory 602, and/or other information as would be understood by one of ordinary skill in the art. That is, the processing circuitry 604 may process sensor data from the sensor(s) 610 to determine tracking data. In one or more exemplary embodiments, the audio accessory 602, microphone 102, and/or the receiver 101/200 may be configured to perform adaptive positioned-based audio processing according to the disclosure (e.g., based on tracking data). For example, adaptive positioned-based audio processing may be performed by the audio accessory 602, by the microphone 102, and/or by the receiver 101/200. In aspects where two or more of the devices perform adaptive positioned-based audio processing, one or more devices may perform an initial adaptive positioned-based audio processing on audio signal(s) to generate processed audio signal(s), and one or more of the other devices may perform subsequent positioned-based audio processing on the processed audio signal(s) to generate processed audio output signal(s) 214.

In an exemplary embodiment, the audio accessory 602 may use the sensor(s) 610 to generate sensor data indicative of the location, position, orientation, etc. of the microphone 102 and/or an object (e.g., the face, mouth, lips, nose, cars, eyes, and/or other facial and/or body parts of the user 116 and/or an accessory, object, substance, and/or device worn/held by and/or affixed to the user 116). The sensor data may then be provided to the microphone 102 and/or receiver 101/200. The microphone 102 and/or the receiver 101/200 may then process sensor data from the sensor(s) 610 to facilitate adaptive audio processing of audio signals from the microphone 102.

In one or more aspects, the audio accessory 602 may include a feedback engine 612, which may be configured similar to the feedback engine 112 and/or one or more other notification devices configured to notify the user 116. The feedback may include haptic feedback (e.g., vibration), proprioceptive feedback (e.g., changing of the audio accessory 602 or a portion thereof), tactile feedback (e.g., changing surface texture), and/or other feedback modalities as would be understood by one of ordinary skill in the art. For example, the audio accessory 602 having a round shape as illustrated in FIG. 6 may deform to become more oval shaped to provide a visual indication that is perceivable by the user 116. This feedback modality may be more subtle than other feedback modalities and provide an advantage over, for example, audio feedback (e.g., that may be hard to detect on stage) and/or visual light feedback (e.g., that may be visible to the audience). In an exemplary embodiment, the I/O interface 613 may be configured to output one or more notifications, such as one or more audio and/or visual notifications, which may be used to indicate to the user 116 of a correct or incorrect position of the microphone. For example, the I/O interface 613 may include one or more speakers and/or lights to provide a notification or indicator to the user 116.

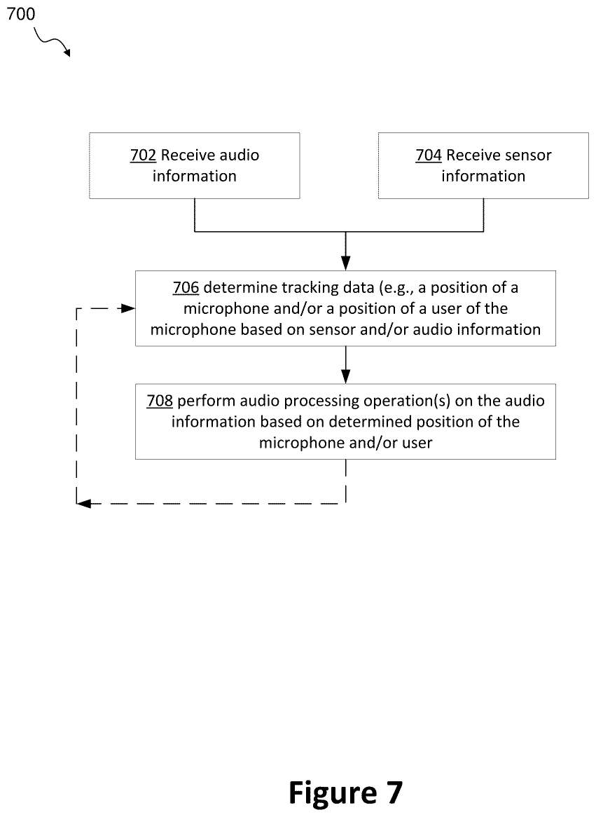

FIG. 7 shows a positioned-based audio processing method 700 according to one or more exemplary embodiments. Two or more of the various operations of the method 700 may be performed simultaneously in one or more aspects. Further, the order of the various operations is not limiting and the operations may be performed in a different order in one or more aspects.

At operation 702, audio information is received. For example, audio signals may be obtained by microphone 102.

At operation 704, sensor information is received. For example, one or more sensors, such as one or more environmental sensors 120 may detect the position, location, orientation, etc. of the microphone 102 and/or the user 116, and generate corresponding sensor information. The determination of the position, location, and/or orientation may include a relational position of the microphone 102 with respect to the user 116.

At operation 706, tracking data corresponding to a position, location, orientation, etc. of the microphone 102 and/or the user 116 is determined based on the sensor information.

At operation 708, one or more audio processing operations is performed on the received audio information based on the determined tracking data. For example, one or more audio processors may perform audio processing on audio signals of the audio information. The audio processing operation(s) may include, for example, panning, equalization (EQ), compression, and/or summing. The operations 706 and 708 may be repeatedly or iteratively performed to provided adaptive audio processing for changes in the determined positional information.

The techniques of this disclosure may also be described in the following paragraphs.

An audio processing device may comprise and object tracker and an audio processor. The object tracker may be configured to determine a position of a microphone and a position of a user using the microphone. The microphone may comprise a single transducer or multiple transducers. The audio processor may be configured to: based on one or both of the determined position of the microphone and the determined position of the user, process an audio signal, using an audio processing algorithm configured to perform one or more frequency-domain adjustments of the audio signal and/or one or more time-domain adjustments of the audio signal, to generate a processed audio signal; and provide the processed audio signal as output of the audio processor. The determined position of the user may comprise a position of a mouth of the user. The frequency-domain adjustment(s) of the audio processing algorithm may comprise audio equalization of the audio signal(s). The time-domain adjustment(s) of the audio processing algorithm comprises one or both of audio compression and limiting of the audio signal(s). The object tracker comprises an on-axis sensor axially arranged on a longitudinal axis of the microphone. The on-axis sensor may comprise a thermal imaging sensor configured to determine one or more facial features of the user. The object tracker may be configured to detect a tracking substance and/or tracking device worn by the user. The tracking substance may comprise an infrared (IR) detectable substance. The tracking substance may be applied to one or more lips of the user, and the object tracker may be configured to determine/detect a position of the lip(s) using the tracking substance. The audio processing device may further comprise a feedback engine configured to generate haptic feedback, proprioceptive feedback, and/or tactile feedback perceivable by the user. the feedback may be generated based on the determined position of the microphone and/or the determined position of the user. A wireless transmitter may comprise the audio processing device, and be configured to removably connect to the microphone and transmit the processed audio signal(s) to a receiver. A microphone may comprise the audio processing device.

An audio processing system may comprise a microphone and a receiver. The microphone may be configured to detect audio and generate a corresponding audio signal. The receiver may be communicatively coupled to the microphone. The receiver may be configured to: determine (e.g., based on sensor data) tracking data corresponding to a position of the microphone and a position of a user of the microphone, perform one or more audio processing operations on the audio signal using an audio processing algorithm (e.g., based on the determined tracking data) to generate a processed audio signal, and provide the processed audio signal as output to the audio processing system. The one or more audio processing operations may include one or more frequency-domain adjustments and/or one or more time-domain adjustments of the audio signal. The audio processing system may further comprise an audio accessory including a sensor configured to generate additional sensor data based on a detected position of the microphone and/or a position of a user of the microphone. The audio accessory may be configured to provide the additional sensor data to the receiver. The receiver may be configured to determine the tracking data further based on the additional sensor data. The audio accessory may comprise a pop filter and/or spit guard positioned between the microphone and the user. The audio processing system may further comprise a wireless transceiver module configured to: removably connect to the microphone, and wirelessly communicate with the receiver to communicatively couple the microphone to the receiver. The wireless transceiver may comprise one or more sensors configured to generate additional sensor data based on a detected position of the microphone and/or a detected position of the user. The receiver may be configured to determine the tracking data further based on the additional sensor data. The audio processing system may further comprise a wireless transceiver module comprising one or more sensors configured to generate additional sensor data based on a detected position of the microphone and/or a detected position of the user. The wireless transceiver module is configured to: removably connect to the microphone, and wirelessly communicate with the receiver to communicatively couple the microphone to the receiver; determine, based on the additional sensor data, additional tracking data; perform one or more audio processing operations on the audio signal from the microphone (e.g., based on the additional tracking data) to generate a second audio signal; and transmit the second audio signal to the receiver.

A microphone may comprise audio transducer(s), sensor(s), and audio processor(s). The audio transducer(s) may be configured to detect audio and generate a corresponding audio signal. The sensor(s) may be configured to detect a position of the microphone and generate sensor data corresponding to the detected position of the microphone. The audio processor(s) may be configured to: based on the detected position of the microphone, process audio signal, using an audio processing algorithm configured to perform one or more frequency-domain adjustments and/or one or more time-domain adjustments of the audio signal, to generate a processed audio signal. The audio processor(s) may provide the processed audio signal(s) as output to the audio processor(s). The sensor(s) may further be configured to detect a position of a user generating the audio detected by the audio transducer(s). The audio processor(s) may process the audio signal(s) further based on the position of the user. The audio processing algorithm may comprise a machine-learning (ML) audio processing algorithm.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein. Memory as described herein may be any well-known volatile and/or non-volatile memory, including, for example, read-only memory (ROM), random access memory (RAM), flash memory, a magnetic storage media, an optical disc, erasable programmable read only memory (EPROM), and programmable read only memory (PROM). The memory can be non-removable, removable, or a combination of both.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

For the purposes of this discussion, the term “processing circuitry” shall be understood to be circuit(s) or processor(s), or a combination thereof. A circuit includes an analog circuit, a digital circuit, data processing circuit, other structural electronic hardware, or a combination thereof. A processor includes a microprocessor, a digital signal processor (DSP), central processor (CPU), application-specific instruction set processor (ASIP), graphics and/or image processor, multi-core processor, or other hardware processor. The processor may be “hard-coded” with instructions to perform corresponding function(s) according to aspects described herein. Alternatively, the processor may access an internal and/or external memory to retrieve instructions stored in the memory, which when executed by the processor, perform the corresponding function(s) associated with the processor, and/or one or more functions and/or operations related to the operation of a component having the processor included therein.

As described herein, the various methods and acts may be operative across one or more devices (e.g., audio devices, computing devices, servers, etc.) and one or more networks. The functionality may be distributed in any manner, or may be located in a single device (e.g., an audio processing device, a server, a client computer, other computing device, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally, or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

1. An audio processing device comprising:
an object tracker configured to determine a position of a microphone and a position of a user using the microphone; and
an audio processor configured to:
based on one or both of the determined position of the microphone and the determined position of the user, process an audio signal, using an audio processing algorithm configured to perform one or more frequency-domain adjustments of the audio signal and one or more time-domain adjustments of the audio signal, to generate a processed audio signal; and
provide the processed audio signal as output of the audio processor.

2. The audio processing device of claim 1, wherein the one or more frequency-domain adjustments of the audio processing algorithm comprises audio equalization of the audio signal.

3. The audio processing device of claim 1, wherein the one or more time-domain adjustments of the audio processing algorithm comprises one or both of audio compression and limiting of the audio signal.

4. The audio processing device of claim 1, wherein the microphone comprises a single transducer.

5. The audio processing device of claim 1, wherein the object tracker comprises an on-axis sensor axially arranged on a longitudinal axis of the microphone.

6. The audio processing device of claim 5, wherein the on-axis sensor comprises a thermal imaging sensor configured to determine one or more facial features of the user.

7. The audio processing device of claim 1, wherein the object tracker is configured to detect a tracking substance or tracking device worn by the user.

8. The audio processing device of claim 7, wherein the tracking substance comprises an infrared (IR) detectable substance.

9. The audio processing device of claim 7, wherein the tracking substance is configured to be applied to one or more lips of the user, the object tracker being configured to detect a position of the one or more lips of the user using the tracking substance.

10. The audio processing device of claim 1, further comprising a feedback engine configured to generate, based on one or both of the determined position of the microphone and the determined position of the user, haptic feedback, proprioceptive feedback, or tactile feedback perceivable by the user.

11. The audio processing device of claim 1, wherein the determined position of the user comprises a position of a mouth of the user.

12. The audio processing device of claim 1, wherein the audio processing algorithm comprises a machine-learning (ML) audio processing algorithm.

13. A wireless transmitter comprising an audio processing device of claim 1, wherein the wireless transmitter is configured to removably connect to the microphone and transmit the processed audio signal to a receiver.

14. An audio processing system comprising:
a microphone configured to detect audio and generate a corresponding audio signal; and
a receiver communicatively coupled to the microphone and configured to:
determine, based on sensor data, tracking data corresponding to a position of the microphone and a position of a user of the microphone;
perform one or more audio processing operations on the audio signal using an audio processing algorithm, based on the determined tracking data, to generate a processed audio signal, wherein the one or more audio processing operations include one or more frequency-domain adjustments and one or more time-domain adjustments of the audio signal; and
provide the processed audio signal as output to the audio processing system.

15. The audio processing system of claim 14, further comprising an audio accessory including a sensor configured to generate additional sensor data based on one or both of a detected position of the microphone and a position of a user of the microphone, wherein the audio accessory is configured to provide the additional sensor data to the receiver, and wherein the receiver is configured to determine the tracking data further based on the additional sensor data.

16. The audio processing system of claim 15, wherein the audio accessory comprises a pop filter or spit guard positioned between the microphone and the user.

17. The audio processing system of claim 14, further comprising a wireless transceiver module configured to: removably connect to the microphone, and wirelessly communicate with the receiver to communicatively couple the microphone to the receiver, wherein the wireless transceiver comprises one or more sensors configured to generate additional sensor data based on one or both of a detected position of the microphone and a detected position of the user, the receiver being configured to determine the tracking data further based on the additional sensor data.

18. The audio processing system of claim 14, further comprising a wireless transceiver module comprising one or more sensors configured to generate additional sensor data based on one or both of a detected position of the microphone and a detected position of the user, wherein the wireless transceiver module is configured to:
removably connect to the microphone, and wirelessly communicate with the receiver to communicatively couple the microphone to the receiver;
determine, based on the additional sensor data, additional tracking data;
perform one or more audio processing operations on the audio signal from the microphone, based on the additional tracking data, to generate a second audio signal; and
transmit the second audio signal to the receiver.

19. A microphone comprising:
an audio transducer configured to detect audio and generate a corresponding audio signal;
a sensor configured to detect a position of the microphone and generate sensor data corresponding to the detected position of the microphone; and
an audio processor configured to:
based on the detected position of the microphone, process audio signal, using an audio processing algorithm configured to perform one or more frequency-domain adjustments and one or more time-domain adjustments of the audio signal, to generate a processed audio signal; and
provide the processed audio signal as output to the audio processor.

20. The microphone of claim 19, wherein the sensor is further configured to detect a position of a user generating the audio detected by the audio transducer, the audio processor processing the audio signal further based on the position of the user.
